(19) United States
(12) Patent Application Publication
(10) Pub. No.: US 2019/0106312 A1
(43) Pub. Date: Apr. 11, 2019

(54) FLUID SUPPLY ASSEMBLY FOR REMOVING GAS BUBBLES FROM A FLUID PATH

(71) Applicant: Groninger & Co. GmbH, Crailsheim (DE)

(72) Inventors: Egmont Semmler, Crailsheim (DE); Josef Veile, Westhausen (DE)

(21) Appl. No.: 16/148,233

(22) Filed: Oct. 1, 2018

(30) Foreign Application Priority Data
Oct. 6, 2017 (DE) 10 2017 123 296.6

(51) Int. Cl. B67C 3/28; B67C 3/00; B01D 19/00

(52) U.S. Cl. CPC B67C 3/286; B01D 19/0063; B67C 3/007

(57) ABSTRACT

A fluid supply assembly having a multi-way valve unit which comprises at least one inlet and at least one first and one second outlet. The fluid supply assembly comprises at least one first fluid path for feeding a fluid from a product tank, wherein the at least one first fluid path is in fluid connection with the at least one inlet of the multi-way valve unit. The fluid supply assembly comprises a second fluid path for directing a fluid to a filling unit, wherein the second fluid path is in fluid connection with the first outlet of the multi-way valve unit. The fluid supply assembly comprises at least a first sensor for detecting gas bubbles in the at least one first fluid path, and wherein the fluid supply assembly has a control unit for controlling the multi-way valve unit, wherein the control unit is coupled to the at least one first sensor.

### CROSS-REFERENCE TO RELATED APPLICATIONS

This application claims the priority of German patent application DE 10 2017 123 296.6, filed on Oct. 6, 2017, the entire content of which is herein incorporated by reference.

### BACKGROUND OF THE INVENTION

The present invention relates to a fluid supply assembly. The present invention further relates to a filling device and a packaging machine with a fluid supply assembly of this kind. The present invention further relates to a method for controlling a fluid supply assembly, more particularly for removing gas bubbles from a fluid path.

Packaging machines with filling devices are generally used to fill fluids, more particularly for pharmaceutical or cosmetic use, into containers, and to close the containers in a follow-up process. It is possible that gas bubbles may occur during the filling process. The gas bubbles more particularly appear here in dosing devices and in pumps, more particularly through taking in air. Gas bubbles can furthermore arise through gas emissions from the fluid during the filling process. Untight places in the tubes or connecting sites between individual component parts of the filling device can furthermore lead to the appearance of gases.

The gas bubbles which appear influence the accuracy of the filling process. Particularly in the field of pharmaceutics an exact dosing of the filling amount is however of great importance.

Filling devices are known which deal with removing air bubbles from filling installations. Filling installations are furthermore known which by way of example attempt to minimize the effect of the gas bubbles by a top-up dosing and thus to reach a precise dosage of the filling quantity.

By way of example, document DE 10 2010 043 160 A1 discloses a filling device for filling a container, more particularly with a pharmaceutical fluid, comprising a first filling unit which carries out a partial filling of the container and only partially fills the container, a second filling unit which carries out a final filling of the container and finally fills the container, at least one set of scales which weighs the empty container, the partially filled container and the finally filled container, and a control unit which is connected to the first filling unit, the second filling unit and the scales and is designed to control the first and second filling unit based on the detected values of the weighing processes by the scales.

Document DE 10 2014 200 250 A1 discloses a method for conditioning a filling device for fluid pharmaceuticals into a container, wherein the filling device comprises a first filling unit for filling a main filling quantity and a second filling unit for dosing a top-up quantity from a difference between the total filling quantity and the main quantity, and a first weighing device, wherein before the production phase in which the containers are filled by means of two filling units, a conditioning phase takes place in which the total filling quantity is only added into the container through the second filling unit, and wherein the conditioning phase serves more particularly to remove air bubbles in the production path of the second filling unit.

Document WO 2011/130601 A1 shows further a valve arrangement which is used more particularly to control fluids of a process line system.

Document U.S. Pat. No. 7,403,125 D2 shows further a system with a fluid path with a query zone. The fluid is analyzed in the query zone with optical methods which are prior art. The system further comprises an air bubble sensor and one pump each at the start and end of the fluid path. The two pumps and the air bubble sensor are connected to a control unit. If the air bubble sensor detects air bubbles in the fluid path, the control unit implements a previously determined reaction. This reaction can be a warning signal sent to the user, marking of the corrupt data or preventing the recording of data and retrieval of samples until the query zone is free of air bubbles.

The document WO 2007/019568 A2 shows a device for delivering fluid which is designed to deliver a predetermined amount of fluid. The device consists of a fluid reservoir to hold the fluid which is to be dosed, a dosing pipeline system for dosing the fluid, and a lift mechanism. The fluid reservoir receives the fluid from a fluid store. The dosing tube has a dosing outlet and is connected to an outlet connection of the fluid reservoir. The lift mechanism changes the relative vertical position between the dosing outlet and the outlet connection so that the fluid can be dosed when the dosing outlet is lower than the outlet connection and is not dosed when the dosing outlet is higher than the outlet connection.

The document EP 2 663 771 B1 shows a piston pump for conveying a fluid, comprising at least a cylinder with a piston which can be moved inside the cylinder along the longitudinal axis of the cylinder by means of a drive, wherein each cylinder has at one side end a mounting flange with at least one cylinder opening and on the cylinder side between each piston and a mounting flange a chamber is formed with variable volume when the associated piston is moved in the cylinder. The piston pump further has an inlet pipe for supplying the fluid and an outlet pipe for discharging the fluid.

It is therefore an object of the present design to provide an improved fluid supply assembly and an improved method for controlling a fluid supply assembly for removing air bubbles from a filling process, more particularly for a filling device of a packaging machine.

### BRIEF SUMMARY OF THE INVENTION

According to a first aspect, a fluid supply assembly is therefore proposed having a multi-way valve unit, wherein the multi-way valve unit comprises at least one inlet and at least one first and one second outlet, wherein the fluid supply assembly comprises at least one first fluid path for feeding a fluid from a product tank, wherein the at least one first fluid path is in fluid connection with the at least one inlet of the multi-way valve unit, wherein the fluid supply assembly comprises a second fluid path for diverting a fluid to a filling device, wherein the second fluid path is in fluid connection with the first outlet of the multi-way valve unit, wherein the fluid supply assembly comprises at least a first sensor for detecting gas bubbles in the at least one first fluid path, and wherein the fluid supply assembly has a control unit for controlling the multi-way valve unit, wherein the control unit is coupled to the at least one first sensor.

According to a second aspect, a filling device is proposed having a fluid supply assembly according to the first aspect or one of its configurations and with a filling unit.

According to a third aspect, a packaging machine is proposed having a product tank, with a pump and a filling device according to the second aspect or one of its configurations.

According to a fourth aspect, a method is proposed for controlling a fluid supply assembly, having the following steps:
providing a fluid connection between at least a first fluid path which is in fluid connection with a product tank, and a second fluid path, which is in fluid connection with a filling device by means of a multi-way valve unit which has at least one inlet and at least a first and a second outlet, wherein the at least one first fluid path is in fluid connection with the at least one inlet of the multi-way valve unit and the second fluid path is in fluid connection with the first outlet of the multi-way valve unit;
feeding a fluid from the product tank through the at least one first fluid path and the at least one inlet of the multi-way valve unit to the multi-way valve unit;
first detecting gas bubbles in the first fluid path by means of at least one first sensor which is coupled to a control unit;
first controlling the multi-way valve unit by means of the control unit for producing a fluid connection between the at least one first fluid path and the at least one second outlet; and
second controlling the multi-way valve unit by means of the control unit for producing a fluid connection between the at least one first fluid path and the second fluid path when no gas bubbles are detected within a predetermined time interval.

It is possible in this way to remove air bubbles from the fluid supply, without any great loss or too much excess of fluid, more particularly of a pharmaceutical or cosmetic fluid. Pharmaceutical and cosmetic fluids are more particularly relatively expensive. Reducing the excess of fluid thus involves reducing the costs.

Furthermore, through the fluid supply assembly and the method for controlling the fluid supply assembly the possibility arises of removing air bubbles in targeted manner from the fluid supply. This makes for example a one-off ventilation at the start of the filling process in a conditioning phase or however the top-up dosing by means of a second filling device superfluous.

In one refinement of the fluid supply assembly it may be proposed that the at least one first sensor is an acoustic, optical or electronic sensor.

Acoustic and electronic, but also optical, sensors are particularly suitable for detecting gas bubbles in a fluid path with a high reliability. It is however also conceivable that other types of sensors can be used for detecting gas bubbles in the first fluid path.

In a further refinement of the fluid supply assembly it may be proposed that the at least one first fluid path comprises a first front portion, a first detection portion and a first rear portion, wherein the at least one first sensor is arranged to detect the gas bubbles only in the first detection portion of the at least one first fluid path.

Many types of sensors can detect gas bubbles only in a specific restricted region. To control the valve unit and to discharge the gas bubbles out from the first fluid path it is advantageous if the arrangement of this region inside the first fluid path is known. The position of the gas bubbles in the first fluid path can thus be determined at least approximately. The control unit can now take this information into consideration in order to control the valve unit in appropriate manner.

There is already a range of commercially available sensors, more particularly ultrasound sensors, electrical or optical sensors, which operate with a high degree of accuracy and can be adapted individually to the dimensions of a fluid path, more particularly a tube or pipe. Many commercially available sensors also have user-specific programmable microcontrollers.

In a further refinement of the fluid supply assembly it may be proposed that the at least one first fluid path and/or the second fluid path are each formed from plastic, metal or a metal alloy.

The fluid paths are simple to make from these materials. These materials are more particularly suitable for use in the pharmaceutical or cosmetic field.

In a further refinement of the fluid supply assembly it may be proposed that the at least one first fluid path and/or second fluid path are formed as disposable parts.

A disposable part is in the conventional sense a component which is designed so that it only serves for a single use. Known disposable parts are for example syringes or gloves which are frequently also provided with the term “single-use”. Disposable parts are as a rule manufactured cost-effectively and are particularly used in the medicinal and cosmetic fields because there the costs and effort of cleaning, more particularly filling devices, often exceeds the costs of the individual components. Cleaning is very laborious, particularly in the pharmaceutical and cosmetic field since the cleanliness and hygiene is of great importance by way of example in the case of filling installations. The smallest residues of fluid from a previous use can lead to impurity in the filling process. Plastic is particularly suitable for manufacturing disposable parts.

If easily exchangeable components such as by way of example the at least one fluid path and/or the second fluid path are formed as disposable parts then these can be replaced after use. Disposable parts are as a rule simple and cost-effective to manufacture. Thus, in particular a more cost-efficient operation of the fluid supply assembly can be produced.

In a further refinement of the fluid supply assembly it may be proposed that the multi-way valve unit is made from plastic, metal or a metal alloy.

As already mentioned, these materials are particularly suitable for use in the pharmaceutical field.

In a further refinement of the fluid supply assembly it may be proposed that the multi-way valve unit is formed as a disposable part.

As already mentioned, the costs and effort in cleaning a filling device, particularly in the pharmaceutical or cosmetic field, can exceed the costs of the individual components of the filling device. For cleaning is very laborious, particularly in the pharmaceutical and cosmetic field since the purity and cleanliness of the filling installations is of great importance there.

Easily exchangeable components, such as by way of example the multi-way valve unit can therefore be formed as disposable parts. Disposable parts are as a rule simple and cost-effective to produce. Thus, in particular a more cost-effective operation of the fluid supply assembly can arise.

In a further refinement of the fluid supply assembly it may be proposed that the fluid supply assembly has two first fluid paths for feeding a fluid from a product tank, wherein the two first fluid paths are each in fluid connection with an inlet of the multi-way valve unit.

By using two fluid paths it is possible to increase the reliability by way of example. If one of the two fluid paths fails then the other fluid path conveys the fluid further on.

In a further refinement of the fluid supply assembly it may be proposed that the fluid supply assembly comprises two first sensors.

In this way it can be possible that if one of the two first sensors does not recognize a gas bubble then the other first sensor in the same fluid path can possibly recognize the gas bubble.

For this the two first sensors can be selected more particularly from different types, by way of example acoustic, optical or electronic sensors. By way of example the one first sensor could be designed as an acoustic sensor and the other first sensor can be designed as an electronic sensor.

In a further refinement of the fluid supply assembly it may be proposed that each one of the two first sensors is assigned just to one of the two first fluid paths in order to detect gas bubbles in the relevant first fluid path.

In this way it can be possible to detect which of the fluid paths contains just gas bubbles. Thus, this one fluid path could be deliberately deaerated.

In a further refinement of the fluid supply assembly it may be proposed that the fluid supply assembly comprises a third fluid path for discharging a fluid, wherein the third fluid path is in fluid connection with the second outlet of the multi-way valve unit.

In this way the fluid volume which contains the gas bubble can be directed out from the fluid supply assembly. It is thus also possible to collect the fluid outside of the fluid supply assembly.

In a further refinement of the fluid supply assembly it may be proposed that the third fluid path is formed from plastic, metal or a metal alloy.

The fluid path is simple to produce from these materials. More particularly these materials are suitable for use in the pharmaceutical or cosmetic field.

In a further refinement of the fluid supply assembly it may be proposed that the third fluid path is formed as a disposable part.

As already mentioned, the costs and effort of cleaning a filling device in the pharmaceutical or cosmetic field can exceed the costs of the individual components of the filling device. For cleaning is very laborious particularly in the pharmaceutical and cosmetic field since the purity and cleanliness of the filling installations is of great importance there.

Easily exchangeable components, such as by way of example the third fluid path, can therefore be designed as a disposable part. Disposable parts are as a rule easy and cost-effective to produce. Thus, a more cost-effective operation of the fluid supply assembly can more particularly be produced.

In a further refinement of the fluid supply assembly it may be proposed that the fluid supply assembly comprises at least a second sensor for detecting gas bubbles in the third fluid path, wherein the at least one second sensor is coupled to the control unit.

In this way the control unit can receive information when a gas bubble which was possibly detected at the first sensor, has passed the second sensor. A more precise control of the fluid supply assembly can thus be possible.

In a further refinement of the fluid supply assembly it may be proposed that the at least one first sensor and the at least one second sensor are structurally identical.

In this way it can be avoided that the second sensor does not detect a gas bubble which the first sensor has detected. The fluid supply assembly is preferably controlled so that the multi-way valve unit discharges fluid at least until the second sensor detects the gas bubble in order to ensure that the gas bubble has been discharged from the production path.

In a further refinement of the fluid supply assembly it may be proposed that the at least one second sensor is an acoustic, optical or electronic sensor.

An acoustic and electronic, but also optical sensor is more particularly suitable to detect gas bubbles in a fluid path with high degree of security. It is however also conceivable that other types of sensors can be used for detecting gas bubbles in the third fluid path.

In a further refinement of the fluid supply assembly it may be proposed that the third fluid path has a second front portion, a second detection portion and a second rear portion, wherein the at least one second sensor is arranged in order to detect the gas bubbles only in the second detection portion of the third fluid path.

Many types of sensors can detect gas bubbles only in a specific restricted region. For controlling the valve unit and for discharging the gas bubbles from the third fluid path it is advantageous if the arrangement of this region inside the third fluid path is known. The position of the gas bubbles in the third fluid path can thus be determined at least approximately. The control unit can take this information into consideration in order to suitably control the multi-way valve unit.

In a further refinement of the fluid supply assembly it may be proposed that the third fluid path is configured to direct the fluid into a collecting container.

In this way the fluid with the gas bubbles can be collected without the fluid supply assembly becoming contaminated.

In a further refinement of the fluid supply assembly it may be proposed that the third fluid path is designed to return the fluid into the product tank.

In this way the fluid which is discharged with the gas bubble is not lost but is returned into the product tank. This can signify a saving of costs particularly in the case of pharmaceutical or cosmetic fluids which are very expensive.

In a further refinement of the fluid supply assembly it may be proposed that the third fluid path has a degassing unit.

If the fluid is returned into the product tank then the degassing unit offers the possibility of removing the gas bubbles from the third fluid path. These can then not be introduced into the filling process again.

A degassing unit is a device for separating fluid and gas. The degassing unit preferably discharges the fluid and gas separately. A degassing unit accordingly preferably has one inlet and two outlets.

A simple example for a degassing unit is a container which has a first opening at the upper end for discharging the gas, a second opening at a lower end for discharging the fluid, and a third opening at a side face for introducing gas-containing fluid. The container is thus arranged so that as a result of the different densities of the fluid and gas, and gravity, the gas collects in an upper region of the container and the fluid collects in a lower region of the container. However other refinements of a degassing unit are also conceivable.

In a further refinement of the fluid supply assembly it may be proposed that the fluid supply assembly has in addition to the third fluid path a further third fluid path, wherein the third fluid path is designed to discharge the fluid into a collecting container, and wherein the further third fluid path is designed to return the fluid to the product tank.

In this way a decision can deliberately be made as to whether the fluid volume which contains a gas bubble and has to be discharged accordingly, is discharged into a collecting container or is to be returned into the product tank. If the gas bubble has by way of example a volume which occupies the complete first fluid path or a major part of the first fluid path, there is then the possibility of diverting this gas bubble completely out of the filling cycle, without having to return it.

In a further refinement of the fluid supply assembly it may be proposed that the further third fluid path has a degassing unit.

If the fluid is returned into the product tank then the degassing unit offers the possibility of removing the gas bubbles out from the further third fluid path. These can then not be re-introduced into the filling process.

In a further refinement of the fluid supply assembly it may be proposed that the product tank has a degassing unit.

If the fluid is returned into the product tank then the degassing unit offers the possibility of removing the gas bubbles from the fluid in the product tank. These can thus not be re-introduced back into the filling process.

It can preferably be proposed that the product tank is designed so that it separates the fluid and gas from one another. More particularly the inflow into the product tank could take place in the portion of the product tank in which the gas layer is arranged. The outflow from the product tank could take place more particularly in the portion of the product tank in which the fluid layer is arranged.

In a further refinement of the fluid supply assembly it may be proposed that the fluid supply assembly has two second sensors.

In this way it can be possible that if one of the two second sensors does not detect a gas bubble then the other second sensor in the same fluid path might possibly detect the gas bubble.

For this the two second sensors can more particularly be selected from different types, by way of example acoustic, optical or electronic sensors. The one second sensor could by way of example be designed as an acoustic sensor, and the other second sensor could be designed as an electronic sensor.

In a further refinement of the fluid supply assembly it may be proposed that the one of the two second sensors is assigned to a third fluid path, in order to detect gas bubbles in the third fluid path, and the other of the two second sensors is assigned to the further third fluid path in order to detect gas bubbles in the further third fluid path.

In this way it can be possible to recognize in which of the third fluid paths the gas bubbles are located. The information is suitable for the targeted control of the fluid supply assembly.

In one refinement of the filling device it may be proposed that the filling device comprises at least one filling needle in connection with the second fluid path in order to dispense the fluid into containers, more particularly vials or syringes.

In this way the fluid can be dispensed into the container in a suitably dosed manner.

In a further refinement of the filling device it may be proposed that the filling unit has several filling needles in fluid connection with the second fluid path in order to dispense the fluid into containers, more particularly vials or syringes.

In this way several containers can be filled at the same time which clearly increases the performance capacity of the filling device.

In one refinement of the method for controlling a fluid supply assembly it may be proposed that the at least one fluid path comprises a first front portion, a first detection portion and a first rear portion, wherein the at least one first sensor is arranged in order to detect the gas bubbles only in the first detection portion of the at least one first fluid path.

Many types of sensors can detect gas bubbles only in a specific restricted area. To control the valve unit and to discharge the gas bubbles from the first fluid path it is advantageous if the arrangement of this region inside the first fluid path is known. The position of the gas bubbles in the first fluid path can thus be determined at least approximately. The control unit can now take into consideration this information in order to control the valve unit in a suitable manner, more particularly this information can be used to calculate the predetermined time interval.

In a further refinement of the method for controlling the fluid supply assembly it may be proposed that the method has, after the initial control step, the step of:
discharging the fluid from the multi-way valve unit through the second outlet of the multi-way valve unit into a collecting container.

In this way the fluid can be collected in the collecting container and there can be no contamination of the fluid supply assembly. There are high hygienic regulations particularly in the pharmaceutical field. The purity and cleanliness are therefore preferably to be ensured.

In a further refinement of the method for controlling the fluid supply assembly it may be proposed that in the discharge step the fluid is discharged through the second outlet of the multi-way valve unit and a third fluid path into a collecting container, wherein the second outlet of the multi-way valve unit is in fluid connection with the third fluid path.

In this way the collecting container can be set at any place to which the third fluid path directs the fluid.

In a further refinement of the method for controlling the fluid supply assembly it may be proposed that the method has, after the initial control step, the step of:
returning the fluid from the multi-way valve unit through the second outlet of the multi-way unit and a third fluid path into the product tank, wherein the second outlet of the multi-way valve unit is in fluid connection with the third fluid path.

In this way the fluid which is discharged with the gas bubble is not lost but is returned into the product tank. This can signify a cost-saving particularly in the case of pharmaceutical or cosmetic fluids which are very expensive.

In a further refinement of the method for controlling the fluid supply assembly it may be proposed that in the returning step gas bubbles are removed from the third fluid path by means of a degassing unit arranged in the third fluid path.

If the fluid is directed back into the product tank then the degassing unit offers the possibility of removing the gas bubbles from the third fluid path. These can thus not be introduced back again into the filling process.

It can preferably be proposed that the degassing unit is not arranged in the third fluid path but is arranged in or on the product tank. The product tank can more particularly also be designed as the degassing unit.

In a further refinement of the method for controlling the fluid supply assembly it may be proposed that the method has, before the second control step, the step of:
second detection of gas bubbles in the third fluid path by means of at least a second sensor.

In this way the control unit can receive the information when a gas bubble which might possibly have been detected at the first sensor, has passed the second sensor. A more precise control of the fluid supply assembly is thereby possible. More particularly this information can be used to calculate the predetermined time interval.

In a further refinement of the method for controlling the fluid supply assembly it may be proposed that the third fluid path comprises a second front portion, a second detection portion and a second rear portion, wherein the at least one second sensor is arranged in order to detect gas bubbles only in the second detection portion of the third fluid path.

Many types of sensors can detect gas bubbles only in a specific restricted region. To control the valve unit and discharge the gas bubbles from the third fluid path it is advantageous if the arrangement of this region inside the third fluid path is known. The position of the gas bubbles in the first fluid path can thus be determined at least approximately. The control unit can take this information into account in order to suitably control the multi-way valve unit, more particularly this information can be used in order to calculate the predetermined time interval.

In a further refinement of the method for controlling the fluid supply assembly it may be proposed that the predetermined time interval is greater than a time value which corresponds to the quotient from the overall length of the at least one first fluid path and the set flow rate of the fluid in the at least first fluid path.

In this way a time interval is selected in which the gas bubbles have crossed through the at least first fluid path and have been discharged from the second outlet of the multi-way valve unit.

In a further refinement of the method for controlling the fluid supply assembly it may be proposed that the predetermined time interval is greater than a time value which corresponds to the quotient from the length, which corresponds to an addition of the lengths of the first detection portion and the first rear portion of the at least one first fluid path, and the set flow rate of the fluid in the at least one first fluid path.

In this way a time interval is likewise given in which the air bubbles have left the first fluid path and have been discharged through the second outlet of the multi-way valve unit.

In a further refinement of the method for controlling the fluid supply assembly it may be proposed that the predetermined time interval is greater than a time value which corresponds to the quotient from the length, such as an addition of the lengths of the first detection portion of the at least one first fluid path, the first rear portion of the at least one first fluid path, the second front portion of the third fluid path and the second detection portion of the third fluid path, and the set flow rate of the fluid in the at least one first fluid path.

By way of example two gas bubbles can be detected one after the other by the first sensor and more particularly the second gas bubble can be detected by the first sensor, directly before the first gas bubble is detected by the second sensor in the third fluid path. In this case two gas bubbles can be located between the first and the second sensor in the sub-portions of the first and the third fluid path. In order now to ensure that both gas bubbles are discharged, the time interval ought to be selected more particularly so that the second gas bubble can also reach the second sensor in this time interval.

It is evident that the features previously mentioned and those which are still to be explained below can be used not only in the combination indicated each time, but also in other combinations or alone without departing from the scope of the present invention.

### BRIEF DESCRIPTION OF THE SEVERAL VIEWS OF THE DRAWING

Embodiments of the invention are shown in the drawings and will be explained in further detail in the following description. In the drawings:

FIG. 1 shows a side view of a first embodiment of the fluid supply assembly;

FIG. 2 shows a side view of a second embodiment of a fluid supply assembly;

FIG. 3 shows a side view of a third embodiment of a fluid supply assembly;

FIG. 4 shows a side view of a fourth embodiment of a fluid supply assembly;

FIG. 5 shows a side view of a fifth embodiment of a fluid supply assembly;

FIG. 6 shows a side view of a first embodiment of a filling device;

FIG. 7 shows a side view of a second embodiment of a filling device;

FIG. 8 shows a side view of a first embodiment of a packaging machine;

FIG. 9 shows a side view of a second embodiment of a packaging machine;

FIG. 10 shows a side view of a third embodiment of a packaging machine;

FIG. 11 shows a diagrammatic view of a first embodiment of a method;

FIG. 12 shows a diagrammatic view of a second embodiment of a method;

FIG. 13 shows a diagrammatic view of a third embodiment of a method; and

FIG. 14 shows a diagrammatic view of a further embodiment of a method.

### DETAILED DESCRIPTION OF THE INVENTION

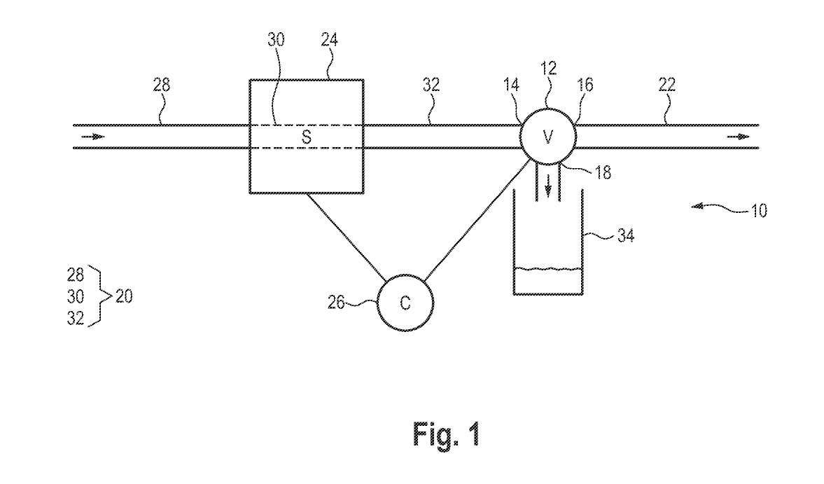

FIG. 1 shows a first embodiment of a fluid supply assembly 10. The fluid supply assembly 10 comprises a multi-way valve unit 12, a first fluid path 20 and a second fluid path 22. The multi-way valve unit 12 comprises an inlet 14, a first outlet 16 and a second outlet 18. The first fluid path 20 is in fluid connection with the inlet 14 of the multi-way valve unit 12 in order to feed fluid from a product tank 58 (not shown) to the multi-way valve unit 12. The second fluid path 22 is in fluid connection with the first outlet 16 of the multi-way valve unit 12 in order to discharge fluid from the multi-way valve unit 12 to a filling device 50 (not shown). A collecting container 34 is arranged underneath the second outlet 18 to collect the fluid being discharged.

The fluid supply assembly 10 furthermore has a first sensor 24. The first fluid path 20 is divided into three portions which are arranged one behind the other in the flow direction of the fluid along the first fluid path. These are a first front portion 28, a first detection portion 30 and a first rear portion 32. The rear portion 32 is arranged at the inlet 14 of the multi-way valve unit 12. The first sensor 24 is arranged in order to detect gas bubbles in the first detection portion 30 of the first fluid path 20. The first sensor 24 can be arranged more particularly in the first detection portion 30 or around the first detection portion 30. It is also furthermore possible that the first sensor 24 has a transmitter and a receiver of acoustic or electrical signals, wherein the transmitter is arranged on one side of the first fluid path 20 and the receiver is arranged on the other side of the first fluid path 20.

The fluid supply assembly 10 comprises furthermore a control unit 26. The control unit 26 is configured to control the multi-way valve unit 12. The first sensor 24 is coupled to the control unit 26. The coupling can more particularly be such that the first sensor 24 of the control unit 26 transmits a signal when the first sensor 24 has detected a gas bubble. The first sensor 24 can also more particularly be designed so as to determine the exact position of the gas bubble inside the first fluid path 20. The first sensor 24 can be designed more particularly to send the precise position of the gas bubble to the control unit 26.

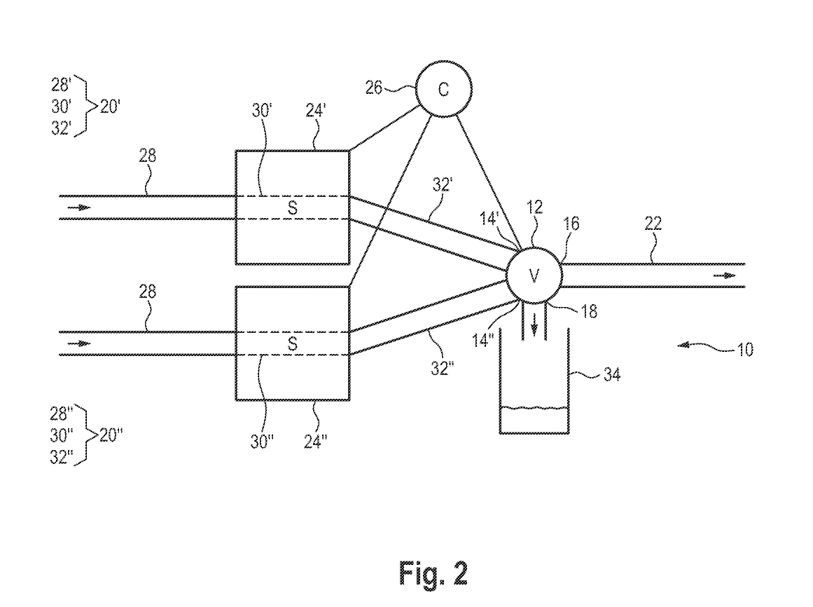

FIG. 2 shows a second embodiment of a fluid supply assembly 10. The fluid supply assembly 10 comprises a multi-way valve unit 12, a first upper fluid path 20′, a first lower fluid path 20″ and a second fluid path 22. The multi-way valve unit 12 comprises a first inlet 14′, a second inlet 14″, a first outlet 16 and a second outlet 18. The upper first fluid path 20′ is in fluid connection with the first inlet 14′ in order to feed fluid from a product tank 58 (not shown) to the multi-way valve unit 12. The lower first fluid path 20″ is in fluid connection with the second inlet 14″ of the multi-way valve unit 12 in order to feed fluid from the product tank 58 (not shown) to the multi-way valve unit 12. The second fluid path 22 is in fluid connection with the first outlet 16 of the multi-way valve unit 12 in order to discharge fluid from the multi-way valve unit 12 to a filling unit 50 (not shown). Underneath the second outlet 18 of the multi-way valve unit 12 is a collecting container 34 in order to collect up the fluid discharged from the second outlet 18.

The upper and the lower first fluid paths 20′, 20″ each have a first front portion 28′, 28″, a first detection portion 30′, 30″ and a first rear portion 32′, 32″. The three portions are arranged one behind the other along the respective first fluid path in the flow direction of the fluid. The first rear portion 32′ of the upper first fluid path 20′ is arranged at the first inlet 14′ of the multi-way valve unit 12. The first rear portion 32″ of the lower first fluid path 20″ is arranged at the second inlet 14″ of the multi-way valve unit 12.

The fluid supply assembly 10 further has an upper first sensor 24 and a lower first sensor 24″. The upper first sensor 24′ is assigned to the upper first fluid path 20′. The lower first sensor 24″ is assigned to the lower first fluid path 20″. The upper first sensor 24′ is arranged so that it can detect gas bubbles in the first detection portion 30′ of the upper first fluid path 20′. The lower first sensor 24″ is arranged so that it can detect gas bubbles in the first detection portion 30″ of the lower first fluid path 20″.

The fluid supply assembly 10 further comprises a control unit 26. The control unit 26 is designed to control the multi-way valve unit 12. The upper first sensor 24′ and the lower first sensor 24″ are coupled to the control unit 26. The two first sensors 24′ and 24″ can be designed more particularly to send a signal to the control unit 26 when the upper first sensor 24′ or the lower first sensor 24″ has detected a gas bubble. The control unit 26 can be designed more particularly to produce after detecting a gas bubble in one of the first fluid paths 20′ and 20″ a fluid connection between the two first fluid paths 20′ and 20″ and the second outlet 18 in order to direct the fluid volume containing a gas bubble into the collecting container 34. The control unit 26 can furthermore be designed more particularly to set a fluid connection between the first fluid path 20′ and 20″ in which no gas bubble was detected, with the first outlet 16, and at the same time to set a fluid connection between the first fluid path 20′ or 20″ in which a gas bubble was detected, with the second outlet 18 of the multi-way valve unit 12.

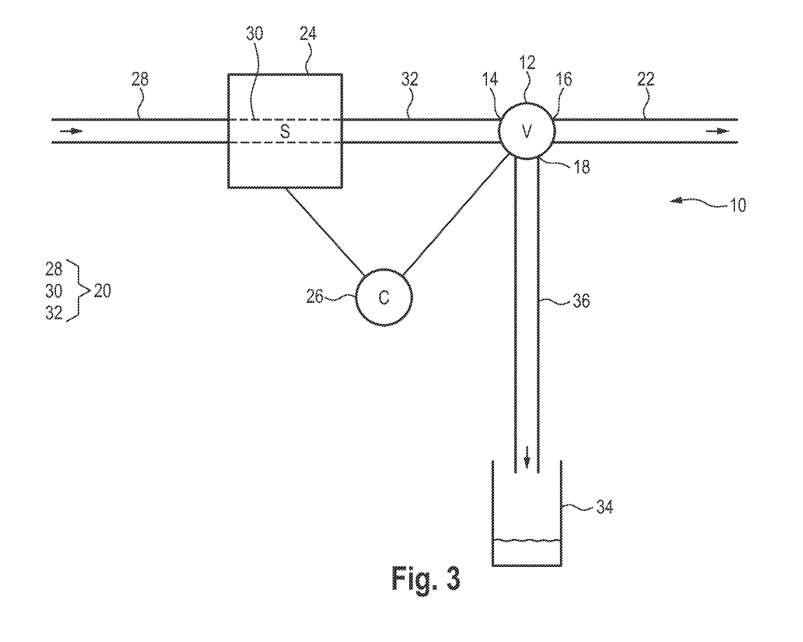

FIG. 3 shows a third embodiment of a fluid supply assembly 10. The fluid supply assembly 10 has a multi-way valve unit 12, a first fluid path 20, a second fluid path 22 and a third fluid path 36. The multi-way valve unit 12 has an inlet 14, a first outlet 16 and a second outlet 18. The first fluid path 20 is in fluid connection with the inlet 14 of the multi-way valve unit 12 in order to feed fluid from a product tank 58 (not shown) to the multi-way valve unit 12. The second fluid path 22 is in fluid connection with the first outlet 16 of the multi-way valve unit 12 in order to discharge fluid from the multi-way valve unit 12 to a filling unit 50 (not shown). The third fluid path 36 is in fluid connection with the second outlet 18 of the multi-way valve unit 12 in order to discharge fluid from the multi-way valve unit 12 into a collecting container 34. The collecting container 34 is arranged underneath an open end of the third fluid path 36, The third fluid path 36 can more particularly be introduced into the collecting container 34.

The fluid supply assembly 10 further comprises a first sensor 24. The first fluid path 20 is divided into three portions which are arranged one behind the other along the first fluid path in the flow direction of the fluid. These are a first front portion 28, a first detection portion 30 and a first rear portion 32. The rear portion 32 is arranged at the inlet 14 of the multi-way valve unit 12. The first sensor 24 is arranged to detect gas bubbles in the first detection portion 30 of the first fluid path 20. The first sensor 24 can be arranged for this more particularly in the first detection portion 30 or around the first detection portion 30. It is furthermore also possible that the first sensor 24 has a transmitter and a receiver of acoustic or electrical signals, wherein the transmitter is arranged on one side of the first fluid path 20 and the receiver is arranged on the other side of the first fluid path 20.

The fluid supply assembly 10 furthermore has a control unit 26. The control unit 26 is designed to control the multi-way valve unit 12. The first sensor 24 is coupled to the control unit 26. The coupling can more particularly be such that the first sensor 24 of the control unit 26 sends a signal when the first sensor 24 has detected a gas bubble. More particularly the first sensor 24 can also be designed to determine the exact position of the gas bubble inside the first fluid path 20. The first sensor 24 can be more particularly designed to send the exact position of the gas bubble to the control unit 26.

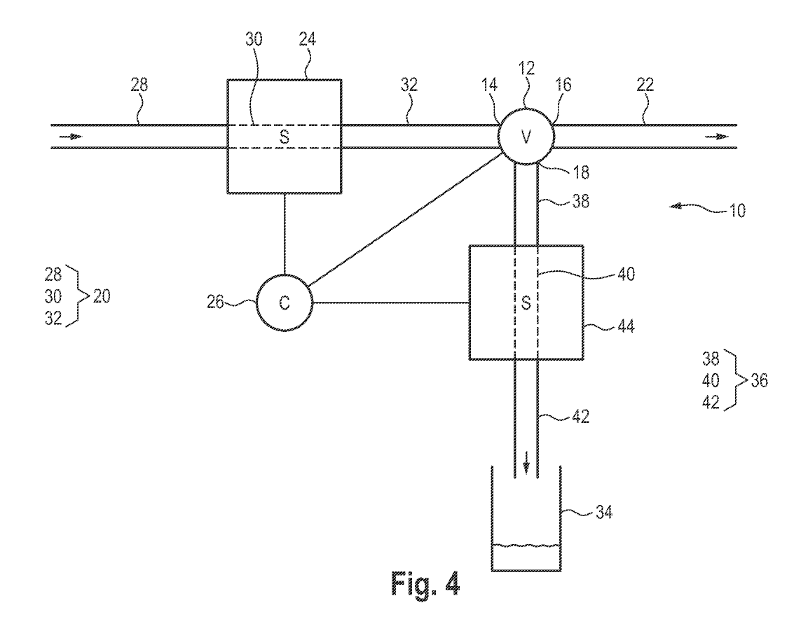

FIG. 4 shows a further embodiment of a fluid supply assembly 10. The fluid supply assembly 10 has a multi-way valve unit 12, a first fluid path 20, a second fluid path 22 and a third fluid path 36. The multi-way valve unit 12 has an inlet 14, a first outlet 16 and a second outlet 18. The first fluid path 20 is in fluid connection with the inlet 14 of the multi-way valve unit 12 in order to feed fluid from a product tank 58 (not shown) to the multi-way valve unit 12. The second fluid path 22 is in fluid connection with the first outlet 16 of the multi-way valve unit 12 in order to discharge fluid from the multi-way valve unit 12 to a filling unit 50 (not shown). The third fluid path 36 is in fluid connection with the second outlet 18 of the multi-way valve unit 12 in order to direct fluid from the multi-way valve unit 12 into a collecting container 34. The collecting container 34 is arranged underneath an open end of the third fluid path 36. The third fluid path 36 can more particularly be introduced into the collecting container 34.

The fluid supply assembly 10 furthermore has a first sensor 24. The first fluid path 20 is divided into three portions which are arranged one behind the other along the first fluid path in the flow direction of the fluid. These are a first front portion 28, a first detection portion 30 and a first rear portion 32. The rear portion 32 is arranged at the inlet 14 of the multi-way valve unit 12. The first sensor 24 is arranged to detect gas bubbles in the first detection portion 30 of the first fluid path 20. The first sensor 24 can be arranged for this more particularly in the first detection portion 30 or around the first detection portion 30. It is also furthermore possible that the first sensor 24 comprises a transmitter and a receiver of acoustic or electrical signals, wherein the transmitter is arranged on one side of the first fluid path 20 and the receiver is arranged on the other side of the first fluid path 20.

The fluid supply assembly 10 further comprises a second sensor 44. The third fluid path 36 has three portions. These are a second front portion 38, a second detection portion 40 and a second rear portion 42. The three portions are arranged one behind the other along the third fluid path 36 in the flow direction of the fluid. The second front portion 38 is arranged at the second outlet 18 of the multi-way valve unit 12. The second sensor 44 is arranged to detect air bubbles in the second detection portion 40. The second sensor 30 can be arranged more particularly in the second detection portion 40 or around the second detection portion 40. It is also furthermore possible that the second sensor 44 comprises a transmitter and a receiver of acoustic or electrical signals, wherein the transmitter is arranged on one side of the third fluid path 36 and the receiver is arranged on the other side of the third fluid path 36.

The fluid supply assembly 10 furthermore has a control unit 26. The control unit 26 is designed to control the multi-way valve unit 12. The first sensor 24 and the second sensor 44 are coupled to the control unit 26. The coupling can consist more particularly of the first sensor 24 and/or the second sensor 44 sending a signal to the control unit 26 when the first sensor 24 and/or the second sensor 44 have detected a gas bubble. The first sensor 24 and the second sensor 44 can more particularly be designed to determine the exact position of the gas bubble inside the first fluid path 20 and/or the third fluid path 36. The first sensor 24 and the second sensor 44 can more particularly be designed to send the exact position of the gas bubble to the control unit 26.

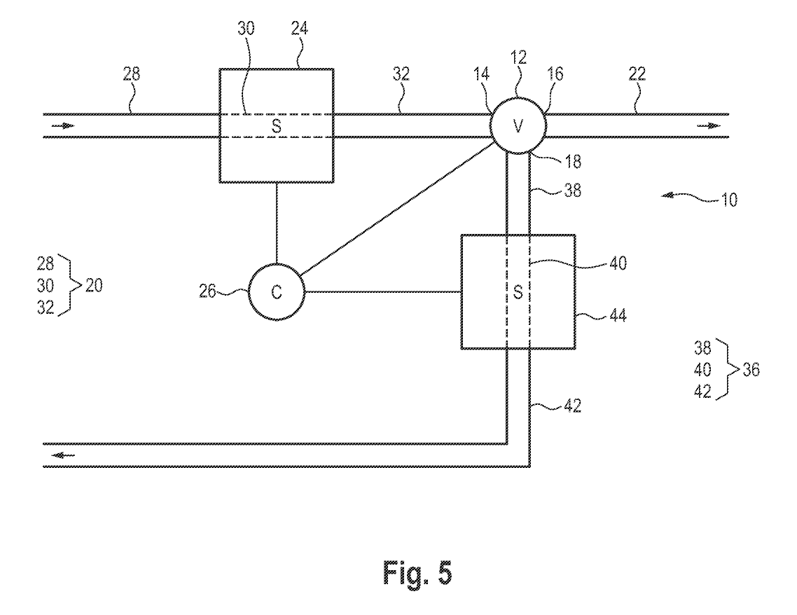

FIG. 5 shows a fifth embodiment of a fluid supply assembly 10. The fluid supply assembly 10 has a multi-way valve unit 12, a first fluid path 20, a second fluid path 22 and a third fluid path 36. The multi-way valve unit 12 has an inlet 14, a first outlet 16 and a second outlet 18. The first fluid path 20 is in fluid connection with the inlet 14 of the multi-way valve unit 12 in order to feed fluid from a product tank 58 (not shown) to the multi-way valve unit 12. The second fluid path 22 is in fluid connection with the first outlet 16 of the multi-way valve unit 12 in order to discharge fluid from the multi-way valve unit 12 to a filling unit 50 (not shown). The third fluid path 36 is in fluid connection with the second outlet 18 of the multi-way valve unit 12 in order to return fluid from the multi-way valve unit 12 into the product tank 58 (not shown).

The first fluid path 20 has a first front portion 28, a first detection portion 30 and a first rear portion 32. The portions are arranged along the first fluid path 20 in the flow direction of the fluid. The first rear portion 32 of the first fluid path 20 is arranged at the inlet 14 of the multi-way valve unit 12. The fluid supply assembly 10 furthermore has a first sensor 24. The first sensor 24 is arranged to detect gas bubbles in the first detection portion 30 of the first fluid path 20.

The third fluid path has a second front portion 38, a second detection portion 40 and a second rear portion 42. The portions are arranged along the third fluid path 36 in the flow direction of the fluid. The second front portion 38 of the third fluid path 36 is arranged at the second outlet 18 of the multi-way valve unit 12. The fluid supply assembly 10 furthermore has a second sensor 44. The second sensor 44 is arranged to detect gas bubbles in the second detection portion 40 of the third fluid path 36.

The fluid supply assembly 10 furthermore has a control unit 26. The control unit 26 is for this purpose designed to control the multi-way valve unit 12. The first sensor 24 and the second sensor 44 are coupled to the control unit 26. The third fluid path can more particularly have a degassing unit 62 (not shown) which removes gas bubbles from the third fluid path. The degassing unit 62 can be arranged here more particularly in the second rear portion 42. It is also conceivable more particularly that the degassing unit 62 is integrated in the product tank 58 (not shown).

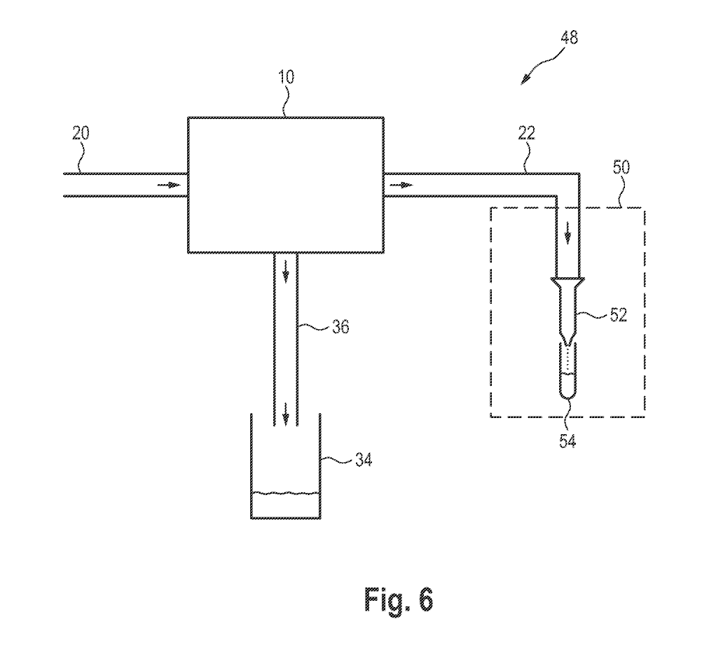

FIG. 6 shows a first embodiment of a filling device 48. The filling device 48 has a fluid supply assembly 10 and a filling unit 50. The fluid supply assembly 10 comprises a first fluid path 20, a second fluid path 22 and a third fluid path 36. The first fluid path 20 is designed to feed fluid from a product tank 58 (not shown) to the fluid supply assembly 10. The second fluid path 22 is designed to direct fluid from the fluid supply assembly 10 to the filling unit 50. The third fluid path 36 is designed to discharge the fluid from the fluid supply assembly into a collecting container 34. The filling unit 50 has a filling needle 52 and a container 54. The container can be by way of example a vial or a syringe. The container 54 is filled with the fluid through the filling needle 52.

A plurality of containers 54 can be filled by way of example in succession with the fluid through the filling needle. The containers can be arranged for this by way of example on a conveying line which supplies the containers 54 to the filling needle 52 in order to be filled there. The conveying line could also move the containers 54 away again from the filling device 48 and supply them by way of example to a closing unit in which the containers 54 are closed.

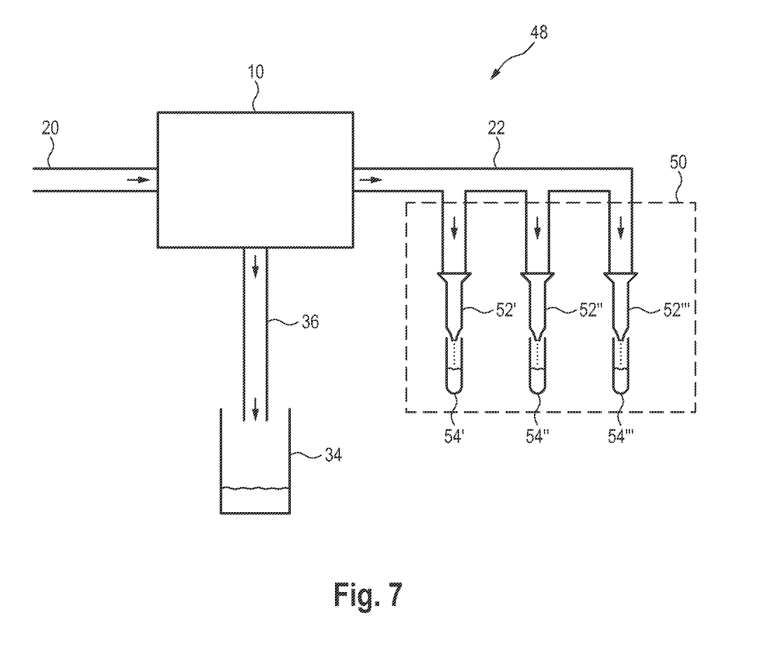

FIG. 7 shows a second embodiment of a filling device 48. The filling device 48 comprises a fluid supply assembly 10 and a filling unit 50. The fluid supply assembly comprises a first fluid path 20, a second fluid path 22 and a third fluid path 36. The first fluid path 20 is designed to feed a fluid from a product tank 58 (not shown) to the fluid supply assembly 10. The second fluid path 22 is designed to discharge the fluid from the fluid supply assembly 10 into the filling unit 50. The third fluid path 36 is designed to direct the fluid from the fluid supply assembly 10 into a collecting container 34. The filling unit 50 has three filling needles 52′, 52″ and 52″. The filling unit 50 furthermore has three containers 54′, 54″, 54″. The containers 54′, 54″, 54′″ are each arranged under one each of the filling needles 52′, 52″ and 52′″ in order to be filled through the filling needles 52′, 52″, 52′″.

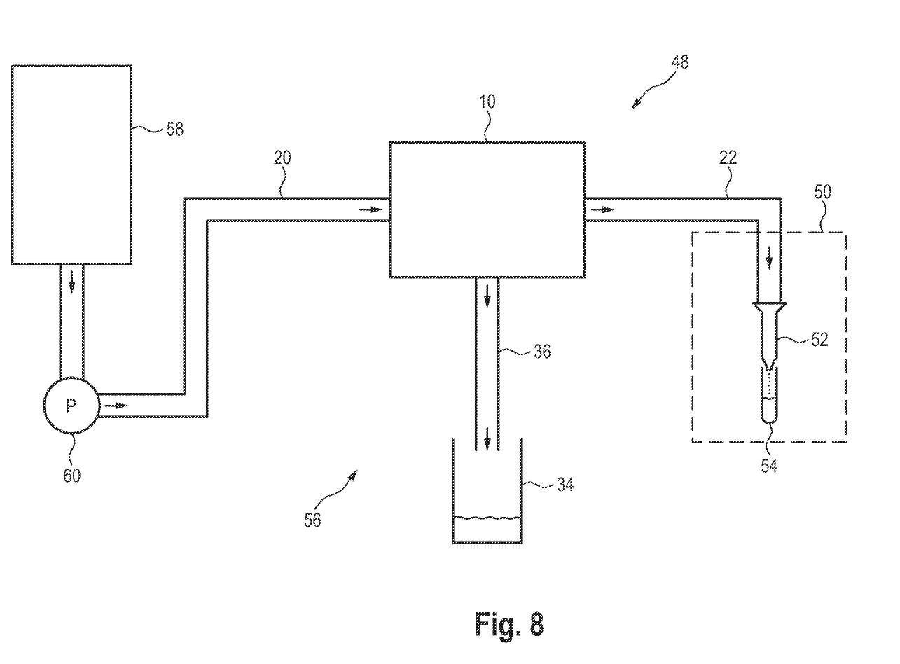

FIG. 8 shows a first embodiment of a packaging machine 56. The packaging machine 56 comprises a product tank 58, a pump 60 and a filling device 48.

The filling device 48 comprises a fluid supply assembly 10 and a filling unit 50. The fluid supply assembly 10 has a first fluid path 20, a second fluid path 22 and a third fluid path 36. The first fluid path 20 is designed to feed fluid from the product tank 58 to the fluid supply assembly 10. For this the pump 60 is arranged inside the first fluid path 20 in order to pump the fluid out from the product tank 58 to the fluid supply assembly 10. The second fluid path 22 is designed to discharge the fluid from the fluid supply assembly 10 to the filling unit 50. The third fluid path 36 is designed to direct the fluid from the fluid supply assembly into a collecting container 34. The filling unit 50 has a filling needle 52 and a container 54. The container can be by way of example a vial or a syringe. The container 54 is filled with the fluid through the filling needle 52.

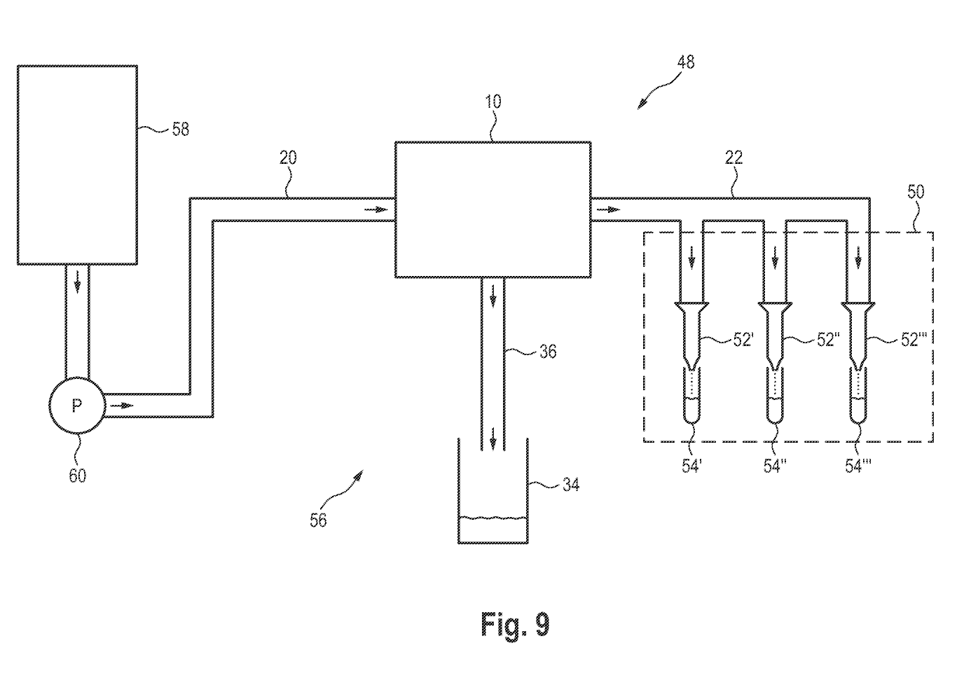

FIG. 9 shows a second embodiment of a packaging machine 56. The packaging machine 56 has a product tank 58, a pump 60 and a filling device 48.

The filling device 48 comprises a fluid supply assembly 10 and a filling unit 50. The fluid supply assembly comprises a first fluid path 20, a second fluid path 22 and a third fluid path 36. The first fluid path 20 is designed to feed a fluid from the product tank 58 to the fluid supply assembly 10. For this, the pump 60 is arranged inside the first fluid path 20 in order to pump the fluid from the product tank 58 to the fluid supply assembly 10. The second fluid path 22 is designed to divert the fluid from the fluid supply assembly 10 into the filling unit 50. The third fluid path 36 is designed to discharge the fluid from the fluid supply assembly 10 into a collecting container 34. The filling unit 50 comprises three filling needles 52′, 52″, and 52″. The filling unit 50 further comprises three containers 54′, 54″ and 54″. The containers 54′, 54″ and 54′″ are each arranged underneath one each of the filling needles 52′, 52″ and 52′″ in order to be filled by the filling needles 52′, 52″, 52″.

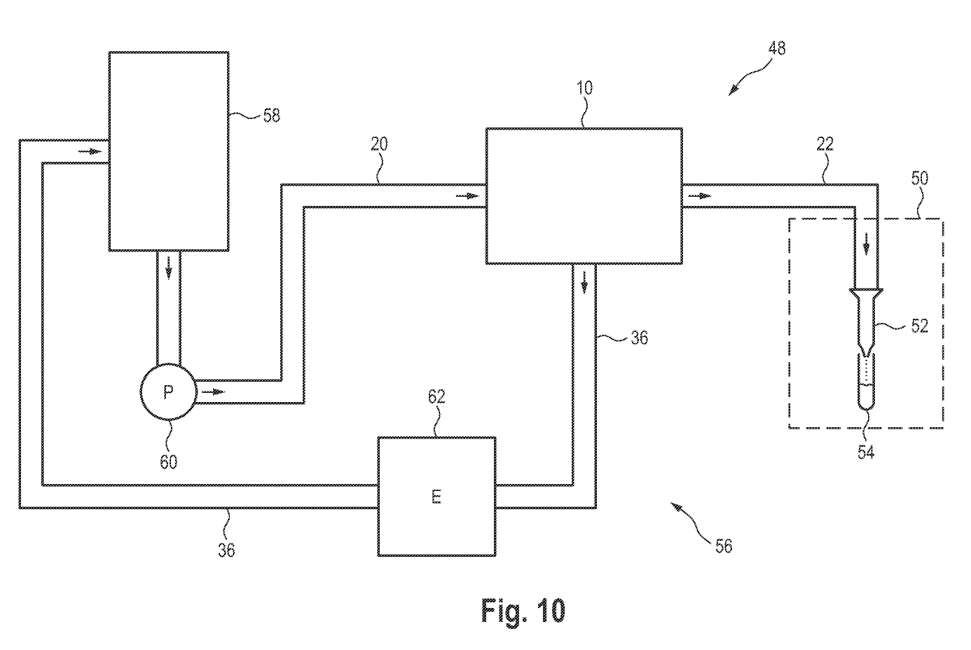

FIG. 10 shows a third embodiment of a packaging machine 56. The packaging machine 56 comprises a product tank 58, a pump 60 and a filling device 48.

The filling device 48 comprises a fluid supply assembly 10 and a filling unit 50. The fluid supply assembly 10 comprises a first fluid path 20, a second fluid path 22 and a third fluid path 36. The first fluid path 20 is in fluid connection with the product tank 58 in order to feed fluid from the product tank 58 to the fluid supply assembly 10. The pump 60 is arranged for this purpose in the first fluid path 20 in order to pump the fluid from the first product tank 58 to the fluid supply assembly 10. The second fluid path 22 is designed to divert the fluid from the fluid supply assembly 10 to the filling unit 50. The filling unit 50 comprises a filling needle 52 and a container 54. The container 54 is arranged underneath the filling needle 52 in order to be filled with fluid through the filling needle 52. The filling needle 52 is in fluid connection with the second fluid path 22. The third fluid path 36 is in fluid connection with the product tank 58. The third fluid path 36 is designed to return the fluid from the fluid supply assembly 10 into the product tank 58. The third fluid path 36 comprises a degassing unit 62. The degassing unit 62 is designed to remove gas bubbles from the third fluid path 36.

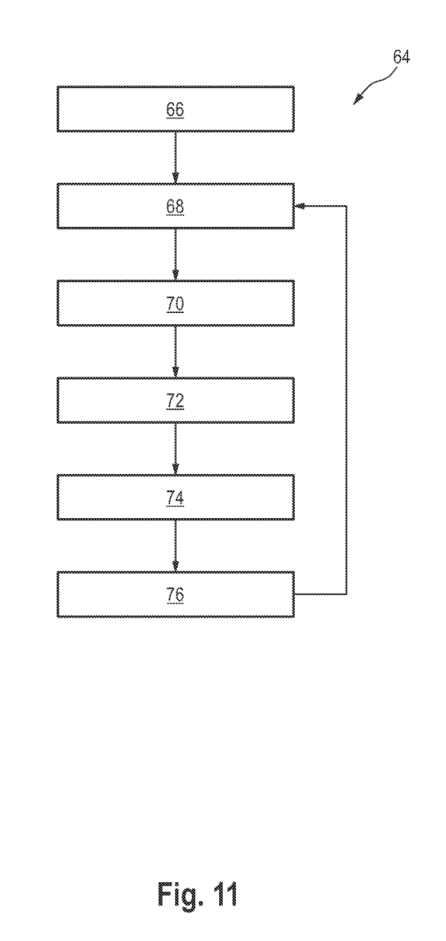

FIG. 11 shows a first embodiment of a method 64 for controlling a fluid assembly 10.

Thus firstly, in a first step 66, a fluid connection can be made between at least a first fluid path 20 and a second fluid path 22 by means of a multi-way valve unit 12. The first fluid path 20 is in fluid connection with a product tank 58. The second fluid path 22 is in fluid connection with a filling unit 50. The multi-way valve unit 12 comprises at least one inlet 14 and at least a first and a second outlet 16, 18. The at least one first fluid path 20 is in fluid connection with the at least one inlet 14 of the multi-way valve unit 12 and the second fluid path 22 is in fluid connection with the first outlet 16 of the multi-way valve unit 12.

In a further step 68 a fluid can be fed from the product tank 58 through the at least one first fluid path 20 and the at least one inlet 14 of the multi-way valve unit 12 to the multi-way valve unit 12.

In a further step 70 the fluid can be discharged from the multi-way valve unit 12 through the first outlet 16 of the multi-way valve unit 12 and the second fluid path 22 to the filling unit 50.

In a further step 72 gas bubbles can be detected in the first fluid path 20 by means of at least one first sensor 24. The at least one first sensor 24 is coupled to a control unit 26.

In a further step 74 the multi-way valve unit 12 can be controlled by means of the control unit 26 in order to produce a fluid connection between the at least one first fluid path 20 and the second outlet 18 in order to direct the fluid out through the second outlet 18.

In a further step 76 the multi-way valve unit 12 can be controlled by means of the control unit 26 in order to produce a fluid connection between at least a first fluid path 20 and the second fluid path 22 when no gas bubbles have been detected within a predetermined time interval.

The predetermined time interval can preferably be greater than a time value which corresponds to the quotient from the overall length of the at least first fluid path 20 and the set flow rate of the fluid in the at least first fluid path 20.

Alternatively, the predetermined time interval can preferably be greater than a time value which corresponds to the quotient from the length, which corresponds to an addition of the lengths of the first detection portion 30 and the first rear portion 32 of the at least one first fluid path 20, and the set flow rate of the fluid in the at least one first fluid path 20.

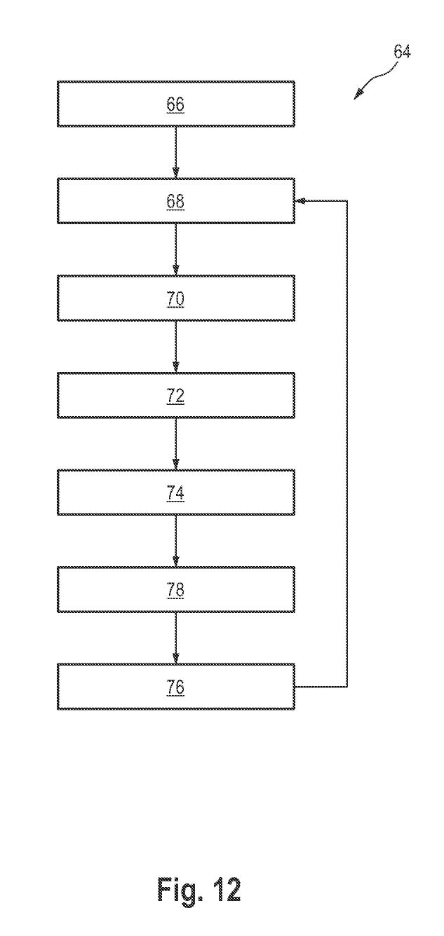

FIG. 12 shows a second embodiment of a method 64 for controlling a fluid supply assembly 10.

Thus firstly, in a first step 66 a fluid connection can be produced between at least a first fluid path 20 and a second fluid path 22 by means of a multi-way valve unit 12. The first fluid path 20 is in fluid connection with a product tank 58. The second fluid path 22 is in fluid connection with a filling unit 50. The multi-way valve unit 12 has at least one inlet 14 and at least a first and a second outlet 16, 18. The at least one first fluid path 20 is here in fluid connection with the at least one inlet 14 of the multi-way valve unit 12, and the second fluid path 22 is in fluid connection with the first outlet 16 of the multi-way valve unit 12.

In a further step 68 a fluid can be fed from the product tank 58 through the at least one first fluid path 20 and the at least one inlet 14 of the multi-way valve unit 12 to the multi-way valve unit 12.

In a further step 70 the fluid can be diverted from the multi-way valve unit 12 through the first outlet 16 of the multi-way valve unit 12 and the second fluid path 22 to the filling unit 50.

In a further step 72 gas bubbles in the first fluid path 20 can be detected by means of at least a first sensor 24. The at least one first sensor 24 is coupled to a control unit 26.

In a further step 74 the multi-way valve unit 12 can be controlled by means of the control unit 26 in order to produce a fluid connection between the at least one first fluid path 20 and the second outlet 18 in order to direct the fluid out through the second outlet 18.

In a further step 78 the fluid can be discharged from the multi-way valve unit 12 through the second outlet 18 of the multi-way valve unit 12 into a collecting container 34. It can be possible more particularly here that the fluid is discharged through the second outlet 18 of the multi-way valve unit 12 and a third fluid path 36 into a collecting container 34, wherein the second outlet 18 of the multi-way valve unit 12 is in fluid connection with the third fluid path 36.

In a further step 76 the multi-way valve unit 12 can be controlled by means of the control unit 26 in order to produce a fluid connection between the at least one first fluid path 20 and the second fluid path 22 when no gas bubbles have been detected within a predetermined time interval.

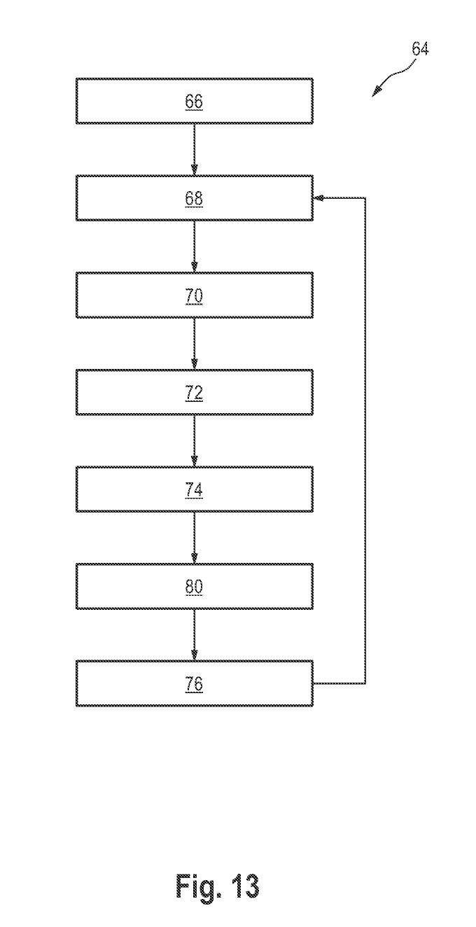

FIG. 13 shows a third embodiment of a method 64 for controlling a fluid supply assembly 10.

Thus, firstly, in a first step 66 a fluid connection can be produced between at least a first fluid path 20 and a second fluid path 22 by means of a multi-way valve unit 12. The first fluid path 20 is in fluid connection with a product tank 58. The second fluid path 22 is in fluid connection with a filling unit 50. The multi-way valve unit 12 comprises at least one inlet 14 and at least a first and a second outlet 16, 18. The at least one first fluid path 20 is then in fluid connection with the at least one inlet 14 of the multi-way valve unit 12 and the second fluid path 22 is in fluid connection with the first outlet 16 of the multi-way valve unit 12.

In a further step 68 a fluid can be fed from the product tank 58 through the at least one first fluid path 20 and the at least one inlet 14 of the multi-way valve unit 12 to the multi-way valve unit 12.

In a further step 70 the fluid can be directed from the multi-way valve unit 12 through the first outlet 16 of the multi-way valve unit 12 and the second fluid path 22 to the filling unit 50.

In a further step 72 gas bubbles in the first fluid path 20 can be detected by means of at least a first sensor 24. The at least one first sensor 24 is coupled to a control unit 26.

In a further step 74 the multi-way valve unit 12 can be controlled by means of the control unit 26 in order to provide a fluid connection between the at least one first fluid path 20 and the second outlet 18 in order to discharge the fluid through the second outlet 18.

In a further step 80 the fluid can be returned from the multi-way valve unit 12 through the second outlet 18 of the multi-way valve unit 12 and a third fluid path 36 into the product tank 58. The second outlet 18 of the multi-way valve unit 12 is in fluid connection with the third fluid path 36. It can more particularly be proposed that during the return, gas bubbles can be removed from the third fluid path 36 by means of a degassing unit 62 arranged in the third fluid path 36. It is then also more particularly possible that the degassing unit 62 is also arranged in or on the product tank 58. It can also more particularly be proposed that the product tank itself is used as the degassing unit.

In a further step 76 the multi-way valve unit 12 can be controlled by means of the control unit 26 in order to produce a fluid connection between the at least one first fluid path 20 and the second fluid path 22 when no gas bubbles have been detected within a predetermined time interval.

More particularly by returning 80 the fluid into the product tank 58 this avoids any fluid from being lost through discharge.

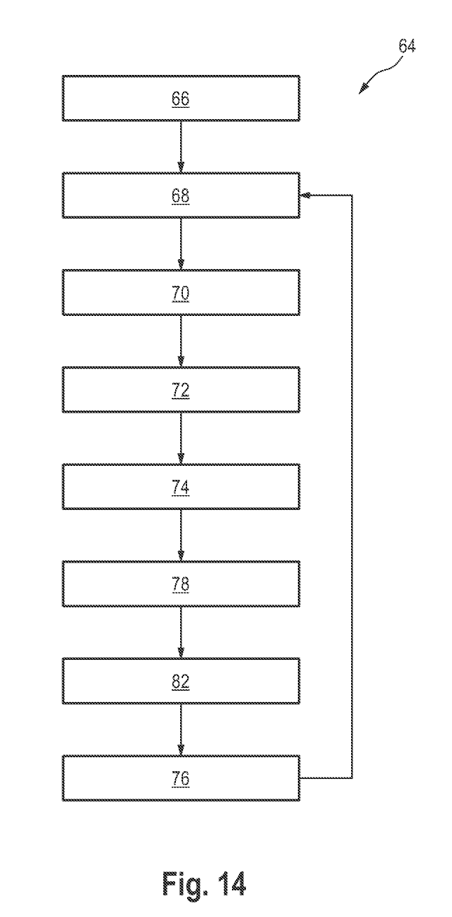

FIG. 14 shows a fourth embodiment of a method 64 for controlling a fluid supply assembly 10.

Thus firstly, in a first step 66, a fluid connection can be produced between at least a first fluid path 20 and a second fluid path 22 by means of a multi-way valve unit 12. The first fluid path 20 is in fluid connection with a product tank 58. The second fluid path 22 is in fluid connection with a filling unit 50. The multi-way valve unit 12 has at least one inlet 14 and at least one first and one second outlet 16, 18. The at least one first fluid path 20 is in fluid connection with the at least one inlet 14 of the multi-way valve unit 12, and the second fluid path 22 is in fluid connection with the first outlet 16 of the multi-way unit 12.

In a further step 68 a fluid can be fed from the product tank 58 through the at least one first fluid path 20 and the at least one inlet 14 of the multi-way valve unit 12 to the multi-way valve unit 12.

In a further step 70 the fluid can be directed from the multi-way valve unit 12 through the first outlet 16 of the multi-way valve unit 12 and the second fluid path 22 to the filling unit 50.

In a further step 72, gas bubbles in the first fluid path 20 can be detected by means of at least a first sensor 24. The at least one first sensor 24 is coupled to a control unit 26.

In a further step 74 the multi-way valve unit 12 can be controlled by means of the control unit 26 in order to produce a fluid connection between the at least one first fluid path 20 and the second outlet 18 in order to discharge the fluid through the second outlet 18.

In a further step 78 the fluid can be directed from the multi-way valve unit 12 through the second outlet 18 of the multi-way valve unit 12 into a collecting container 34. It can then more particularly also be possible that the fluid is discharged through the second outlet 18 of the multi-way valve unit 12 and a third fluid path 36 into a collecting container 34 wherein the second outlet 18 of the multi-way valve unit 12 is in fluid connection with the third fluid path 36.

In a further step 82 gas bubbles in the third fluid path 36 can be detected by means of at least a second sensor 44.

In a further step 76, the multi-way valve unit 12 can be controlled by means of the control unit 26 in order to produce a fluid connection between the at least one first fluid path 20 and the second fluid path 22 when no gas bubbles have been detected within a predetermined time interval.

The predetermined time interval is preferably greater than a time value which corresponds to the quotient from the length which corresponds to an addition of the lengths of the first detection portion 30 of the at least one first fluid path 20, of the first rear portion 32 of the at least one first fluid path 20, of the second front portion 38 of the third fluid path 36 and the second detection portion 40 of the third fluid path 36, and the set flow rate of the fluid in the at least one first fluid path 20.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A fluid supply assembly having a multi-way valve unit which comprises at least one inlet and at least one first and one second outlet, wherein the fluid supply assembly comprises at least one first fluid path for feeding a fluid from a product tank, wherein the at least one first fluid path is in fluid connection with the at least one inlet of the multi-way valve unit, wherein the fluid supply assembly comprises a second fluid path for directing a fluid to a filling unit, wherein the second fluid path is in fluid connection with the first outlet of the multi-way valve unit, wherein the fluid supply assembly comprises at least a first sensor for detecting gas bubbles in the at least one first fluid path, and wherein the fluid supply assembly has a control unit for controlling the multi-way valve unit, wherein the control unit is coupled to the at least one first sensor.

2. The fluid supply assembly according to claim 1, wherein the at least one first sensor is an acoustic, an optical or an electronic sensor.

3. The fluid supply assembly according to claim 1, wherein the at least one first fluid path comprises a first front portion, a first detection portion and a first rear portion, wherein the at least one first sensor is arranged in order to detect the gas bubbles only in the first detection portion of the at least one first fluid path.

4. The fluid supply assembly according to claim 1, wherein the at least one first fluid path and/or the second fluid path are each formed from plastic, a metal or from a metal alloy.

5. The fluid supply assembly according to claim 1, wherein the at least one first fluid path and/or the second fluid path are formed as disposable parts.

6. The fluid supply assembly according to claim 1, wherein the multi-way valve unit is formed from plastic, from a metal or from a metal alloy.

7. The fluid supply assembly according to claim 1, wherein the multi-way valve unit is formed as a disposable part.

8. The fluid supply assembly according to claim 1, wherein the fluid supply assembly comprises two first fluid paths for feeding a fluid from a product tank, wherein the two first fluid paths are each in fluid connection with an inlet of the multi-way valve unit.

9. The fluid supply assembly according to claim 8, wherein the fluid supply assembly comprises two first sensors.

10. The fluid supply assembly according to claim 9, wherein each one of the two first sensors is assigned just to one of the two first fluid paths in order to detect gas bubbles in the respective first fluid path.

11. The fluid supply assembly according to claim 1, wherein the fluid supply assembly comprises a third fluid path for discharging a fluid, wherein the third fluid path is in fluid connection with the second outlet of the multi-way valve unit.

12. The fluid supply assembly according to claim 11, wherein the third fluid path is formed from plastic, a metal or a metal alloy.

13. The fluid supply assembly according to claim 11, wherein the third fluid path is formed as a disposable part.

14. The fluid supply assembly according to claim 11, wherein the fluid supply assembly comprises an at least one second sensor for detecting gas bubbles in the third fluid path, wherein the at least one second sensor is coupled to the control unit.

15. The fluid supply assembly according to claim 14, wherein the at least one first sensor and the at least one second sensor are structurally identical.

16. The fluid supply assembly according to claim 14, wherein the at least one second sensor is an acoustic, an optical or an electronic sensor.

17. The fluid supply assembly according to claim 14, wherein the third fluid path comprises a second front portion, a second detection portion and a second rear portion, wherein the at least one second sensor is arranged in order to detect the gas bubbles only in the second detection portion of the third fluid path.

18. The fluid supply assembly according to claim 11, wherein the third fluid path is designed to discharge the fluid into a collecting container.

19. The fluid supply assembly according to claim 11, wherein the third fluid path is designed to return the fluid into the product tank.

20. The fluid supply assembly according to claim 19, wherein the third fluid path comprises a degassing unit.

21. The fluid supply assembly according to claim 11, wherein the fluid supply assembly has in addition to the third fluid path a further third fluid path, wherein the third fluid path is designed to discharge the fluid into a collecting container, and wherein the further third fluid path is designed to return the fluid into the product tank.

22. The fluid supply assembly according to claim 21, wherein the further third fluid path comprises a degassing unit.

23. The fluid supply assembly according to claim 19, wherein the product tank comprises a degassing unit.

24. The fluid supply assembly according to claim 21, wherein the product tank comprises a degassing unit.

25. The fluid supply assembly according to claim 21, wherein the fluid supply assembly comprises two second sensors.

26. The fluid supply assembly according to claim 25, wherein the one of the two second sensors is assigned to the third fluid path in order to detect gas bubbles in the third fluid path, and the other of the two second sensors is assigned to the further third fluid path in order to detect gas bubbles in the further third fluid path.

27. A filling device with a fluid supply assembly according to claim 1 and with a filling unit.

28. The filling device according to claim 27, wherein the filling unit comprises at least one filling needle in fluid connection with the second fluid path in order to dispense the fluid into containers.

29. The filling device according to claim 27, wherein the filling unit comprises several filling needles in fluid connection with the second fluid path in order to dispense the fluid into containers.

30. A packaging machine having a product tank, a pump and a filling device according to claim 27, wherein the pump is in fluid connection with the product tank and the first fluid path of the filling device in order to pump fluid from the product tank to the filling device.

31. A method for controlling a fluid supply assembly, comprising the following steps:
producing a fluid connection between at least a first fluid path which is in fluid connection with a product tank, and a second fluid path which is in fluid connection with a filling unit, by means of a multi-way valve unit which comprises at least one inlet and at least a first and a second outlet, wherein the at least one first fluid path is in fluid connection with the at least one inlet of the multi-way valve unit and the second fluid path is in fluid connection with the first outlet of the multi-way valve unit;
feeding a fluid from the product tank through the at least one first fluid path and the at least one inlet of the multi-way valve unit to the multi-way valve unit;
directing the fluid from the multi-way valve unit through the first outlet of the multi-way valve unit and the second fluid path to the filling unit;
firstly detecting gas bubbles in the first fluid path by means of at least one first sensor which is coupled to a control unit;
firstly controlling the multi-way valve unit by means of the control unit for producing a fluid connection between the at least one first fluid path and the second outlet; and
secondly controlling the multi-way valve unit by means of the control unit for producing a fluid connection between the at least one first fluid path and the second fluid path, wherein no gas bubbles have been detected within a predetermined time interval.

32. The method according to claim 31, wherein the at least one first fluid path comprises a first front portion, a first detection portion and a first rear portion, wherein the at least one first sensor is arranged in order to detect the gas bubbles only in the first detection portion of the at least one first fluid path.

33. The method according to claim 31, wherein the method comprises, after the first control step, the step of:
discharging the fluid from the multi-way valve unit through the second outlet of the multi-way valve unit into a collecting container.

34. The method according to claim 33, wherein in the discharging step the fluid is discharged through the second outlet of the multi-way valve unit and a third fluid path into a collecting container, wherein the second outlet of the multi-way valve unit is in fluid connection with the third fluid path.

35. The method according to claim 31, wherein the method has, after the first control step, the step of:
returning the fluid from the multi-way valve unit through the second outlet of the multi-way valve unit and a third fluid path into the product tank, wherein the second outlet of the multi-way valve unit is in fluid connection with the third fluid path.

36. The method according to claim 35, wherein in the returning step gas bubbles are removed from the third fluid path by means of a degassing unit which is arranged in the third fluid path.

37. The method according to claim 34, wherein the method has, before the second control step, the step of:
second detection of gas bubbles in the third fluid path by means of at least one second sensor.

38. The method according to claim 37, wherein the third fluid path comprises a second front portion, a second detection portion and a second rear partition, wherein the at least one second sensor is arranged in order to detect gas bubbles only in the second detection portion of the third fluid path.

39. The method according to claim 31, wherein the predetermined time interval is greater than a time value which corresponds to the quotient from the overall length of the at least one first fluid path and the set flow rate of the fluid in the at least one first fluid path.

40. The method according to claim 32, wherein the predetermined time interval is greater than a time value which corresponds to the quotient from the length which corresponds to an addition of the lengths of the first detection portion and the first rear portion of the at least one first fluid path, and the set flow rate of the fluid in the at least one first fluid path.

41. The method according to claim 38, wherein the predetermined time interval is greater than a time value which corresponds to the quotient from the length which corresponds to an addition of the lengths of the first detection portion of the at least one first fluid path, the first rear portion of the at least one first fluid path, of the second front portion of the third fluid path and of the second detection portion of the third fluid path, and the set flow rate of the fluid in the at least one first fluid path.
